(19) United States
(12) Patent Application Publication
(10) Pub. No.: US 2026/0101835 A1
(43) Pub. Date: Apr. 16, 2026

(54) AGRICULTURAL IMPLEMENT AND METHOD OF USING

(71) Applicant: Jim Lyons, Buckingham, PA (US)

(72) Inventor: Jim Lyons, Buckingham, PA (US)

(21) Appl. No.: 19/357,817

(22) Filed: Oct. 14, 2025

Related U.S. Application Data
(60) Provisional application No. 63/707,387, filed on Oct. 15, 2024.

(51) Int. Cl. A01C 7/12; A01C 7/06; A01C 7/20

(52) U.S. Cl. CPC A01C 7/123; A01C 7/06; A01C 7/203

(57) ABSTRACT

An agricultural implement for planting agricultural crops, which reduces the growth of invasive weeds while providing sufficient nutrients to the selected crop to ensure successful crop growth. The agricultural implement delivers a cellulose-based material to an agricultural bed while simultaneously dropping particulate material directly on the cellulose-based material. The agricultural implement stores the particulate material in a hopper, and delivers the cellulose-based material via a roller element in mechanical communication with a rear axle. An agitator or paddle wheel rotates inside the hopper to de-clump the particulate material in order to facilitate particulate material falling into a cylindrical spinner spreader.

### BACKGROUND OF THE INVENTION

### 1. Field of the Invention

The present invention relates to agricultural implements and, more particularly, to agricultural devices for planting agricultural crops. Specifically, the present invention relates to a method and apparatus which reduces the growth of invasive weeds while providing beneficial carbon and nutrients to the selected crop. In addition, the present invention can contribute greatly to the creation of healthy soil conditions by reducing or eliminating entirely the need to disturb the soil with a form of tillage. More specifically, the present invention relates to a combination particulate and cellulose spreader providing the ability to form an agricultural bed consisting of a layer of cellulose material (kraft paper) underneath particulate material (compost).

### 2. Description of Related Art

Farmers are always seeking ways to improve the growth of agricultural crops, and societal pressure has significantly impacted how farmers can accomplish such tasks. Notably, with the increase in demand for organic certified crops, the certification process for farmers to become “certified organic” growers restricts the use of chemical products which can be applied to the agricultural bed of a selected crop to provide necessary nutrients to the soil and inhibit the growth of invasive weeds. Such certification requires farming practices to consider chemical-free inputs, such as natural fertilizers, biological pest controls, companion crop planting, and crop rotation, to name a few. The difficulty of managing pests and weeds without synthetic pesticides present challenges for the farmer.

While the industry standard, polyethylene mulch, may be implemented to stop the growth of invasives weeds, it is not without its shortcomings, the first of which is its creation of ever more single use plastic being added to the waste stream. Second, more attention is recently being paid to micro plastics in the environment and there is concern among soil scientists that micro plastics might be leaching into the soil from the use of plastic mulches. Third, plastic mulch limits the grower to using only transplanted crops, not with direct seeded crops. Fourth, plastic mulch requires that the soil be virtually pulverized so that the plastic edges can be buried. This process adds no nutrition to the soil, the tillage degrades soil structure and water holding capacity, and destroys bacterial and fungal (the soil's microbiome) habitat with the result being less well fed, less healthy, and less nutritious plants requiring chemical fertilizers, pesticides, and fungicides in order for them to make it to harvest. The implementation of the agricultural implement and process of the present invention eliminates or minimizes the amount of tillage normally required. Expanding on the third point made above, with direct seeding the paper mulch yields to the root of the seed planted in the weed free compost on top of the paper allowing it to grow while simultaneously preventing weeds penetrating from below.

Thus, a need exists in the industry for a method and apparatus which reduces the growth of invasive weeds, especially weeds originating from seeds, while providing sufficient nutrients to the selected crop to ensure successful crop growth, especially as a means to assist organic farming.

In situations where tillage can destroy the various components of the soil, the physical, chemical, and biological components, that work synergistically together to create healthy conditions in which plants can thrive, it is desirable to reduce or eliminate the need to disturb the soil with any form of tillage, while reducing invasive weeds and providing nutrition and soil building qualities. The prior art methods do not adequately address these matters.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a perspective view of a first embodiment of an agricultural implement according to the invention;

FIG. 2 depicts a front view of the agricultural implement of FIG. 1;

FIG. 3 depicts a side perspective view of the agricultural implement of FIG. 1;

FIG. 4 depicts a perspective view of a portion of the agricultural implement of FIG. 1, displaying a leading subassembly;

FIG. 5A depicts a perspective view of a portion of the agricultural implement of FIG. 1, displaying a trailing subassembly;

FIG. 5B depicts a perspective view of a portion of the agricultural implement of FIG. 1, displaying a trailing subassembly interior;

FIG. 6 depicts a perspective view of a portion of the agricultural implement of FIG. 1, displaying a mechanical assembly;

FIG. 7 depicts a perspective view of a portion of the agricultural implement of FIG. 1, displaying the trailing subassembly during use;

FIG. 8 depicts a second embodiment of the present invention, showing a perspective view of an agricultural implement;

FIG. 9 depicts a partial view of the rear end of agricultural implement of FIG. 8 showing the sub-assembly and cylindrical spinner spreader for dropping particulate material from a hopper;

FIG. 10 is a close-up view of the sub-assembly and cylindrical spinner spreader of FIG. 9 at the rear axle;

FIG. 11 depicts another embodiment of the rotary drop instrument, providing an isolated view of a cylindrical spinner having a different shaped grating, shown over the agricultural bed;

FIG. 12 is a top view of the agricultural implement of FIG. 8;

FIG. 13 depicts a magnified view of an embodiment of a paddle wheel, having paddle fins shaped to de-clump particulate material upon rotation within the lower portion of the hopper, sending the particulate material to the cylindrical spinner; and

FIG. 14 is a side view of agricultural implement of FIG. 8 depicting the spatial relationship among the roller element that delivers cellulose material to the agricultural bed underneath, and the hopper that retains a paddle wheel to de-clump particulate material within the hopper.

### SUMMARY OF THE INVENTION

Bearing in mind the problems and deficiencies of the prior art, it is therefore an object of the present invention to provide a method and apparatus which reduces the growth of invasive weeds while providing sufficient nutrients to the selected crop to ensure successful crop growth.

In situations where tillage can destroy the various components of the soil, the physical, chemical, and biological components, that work synergistically together to create healthy conditions in which plants can thrive, it is another object of the present invention to greatly reduce or eliminate the need to disturb the soil with any form of tillage while providing nutrients and reducing invasive weeds.

Another object of the present invention is to a combination particulate and cellulose spreader providing the ability to form an agricultural bed consisting of a layer of cellulose material underneath particulate material.

The above and other objects, which will be apparent to those skilled in the art, are achieved in the present invention which is directed to an agricultural implement for spreading particulate material on an agricultural bed, and placing cellulose-based material on the agricultural bed for reducing the growth of invasive weeds while providing sufficient nutrients to the selected particulate material ensuring successful crop growth, the agricultural implement comprising: a forward end, a rearward end, a leading sub-assembly at the forward end followed by a trailing sub-assembly at the rearward end; a hopper for containing the particulate material; the cellulose-based material supported on a delivery apparatus including a roller element secured to a common frame for securing a rotatable roll of the a cellulose-based material for placement over the agricultural bed, which has been seeded with a desired crop; an agitator or paddle wheel including a plurality of paddles or fins situated across a width of the hopper on a rotating axle located within the hopper, the paddles or fins extending radially outwards and rotating under a linkage assembly in mechanical communication with a rear axle; a cylindrical drop or spinner spreader located about a rear axle of the agricultural implement, where the spinner spreader includes a grate-like outside surface having a plurality of apertures for dropping the particulate material therethrough during rotation or spinning; and a controller to control the flow of particulate material to the spinner spreader, allowing for the adjustment and moderation of particulate flow.

The controller may be configured to control application parameters of the particulate material including depth, velocity, and/or coverage degree.

The controller may comprise a manual, hand operated assembly to limit or control the delivery of particulate material to the spinner spreader.

A flow control lever may be utilized to adjust release of the particulate material.

The agitator or paddle wheel rotates to ensure de-clumping and smooth flow of the particulate material falling into the spinner spreader.

The paddle wheel is preferably situated across a width of the hopper on a rotating axle, and rotates via the linkage assembly with a rear axle.

The agricultural implement may also include a rearward apron for the discharge of the particulate material from the hopper, and a bib element secured on a side of the apron extending along sides of the agricultural implement, ensuring the discharge of particulate material onto the agricultural bed.

One or more hydraulic assemblies may be in communication with the controller for the selection of one or more application parameters during the delivery of the particulate material.

Preferably, the cellulose-based material may comprise a paper or paperboard product produced from chemical pulp pursuant to a kraft process, forming kraft paper, and comprises a weight from 30 lb to 90 lb.

In a second aspect, the present invention is directed to a method of treating an agricultural bed utilizing an agricultural implement, the method comprising: traversing the agricultural implement along the agricultural bed; placing cellulose-based material on the agricultural bed for reducing growth of invasive weeds while providing sufficient nutrients to selected particulate material and grow medium, ensuring successful crop growth, wherein the agricultural implement comprises: a forward end, a rearward end, a leading sub-assembly at the forward end followed by a trailing sub-assembly at the rearward end; a hopper for containing the particulate material; the cellulose-based material supported on a delivery apparatus including a roller element secured to a common frame for securing a rotatable roll of the a cellulose-based material for placement over the agricultural bed; an agitator or paddle wheel including a plurality of paddles or fins situated across a width of the hopper on a rotating axle located within the hopper, the paddles or fins extending radially outwards; a cylindrical drop or spinner spreader located about a rear axle of the agricultural implement, where the spinner spreader includes a grate-like outside surface having a plurality of apertures for dropping the particulate material therethrough during rotation or spinning; and a controller to control the flow of particulate material to the spinner spreader, allowing for the adjustment and moderation of particulate flow; and spreading particulate material on the cellulose-based material on the agricultural bed utilizing the agricultural implement.

The method further includes rotating the cylindrical drop or spinner spreader in mechanical communication with the rear axle, and rotating the agitator or paddle wheel under a linkage assembly in mechanical communication with the rear axle.

The method includes moving the agricultural implement along the agricultural path such that the roller element rotates and drops the cellulose-based material onto the agricultural bed, and as the agricultural implement traverses the agricultural path over dropped cellulose-based material, the paddle wheel rotates and causes particulate material to fall out of a bottom end of the hopper onto the cellulose-based material.

### DETAILED DESCRIPTION OF THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the singular forms “a”, “an” and “the” are intended to include the plural forms as well, unless the context clearly indicates otherwise. Also, as used herein, the term “and/or” includes any and all combinations of one or more of the associated listed items. It will be further understood that the terms “include” and/or “including” when used herein, specify the presence of stated features, steps, operations, elements, and/or components, but do not preclude the presence or addition of one or more other features, steps, operations, elements, components, and/or groups thereof.

It will be further understood that when an element is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected,” “coupled”, “operatively coupled”, or the like to another element, it can be directly connected, coupled, or operatively coupled to the other element or intervening elements may be present. Moreover, it can be removable or integral with the other element and/or intervening elements.

Relative terms such as “below,” “above,” “upper,” “lower,” “horizontal,” “vertical,” “top,” “bottom,” “rear,” “front,” “side,” or the like may be used herein to describe a relationship of one element or component to another element or component as illustrated in the figures. It will be understood that these terms are intended to encompass different orientations of the device in addition to the orientation depicted in the figures.

Additionally, in the subject description, the words “exemplary,” “illustrative,” or the like are used to mean serving as an example, instance or illustration. Any aspect or design described herein as “exemplary” or “illustrative” is not necessarily intended to be construed as preferred or advantageous over other aspects or design. Rather, use of the words “exemplary” or “illustrative” is merely intended to present concepts in a concrete fashion.

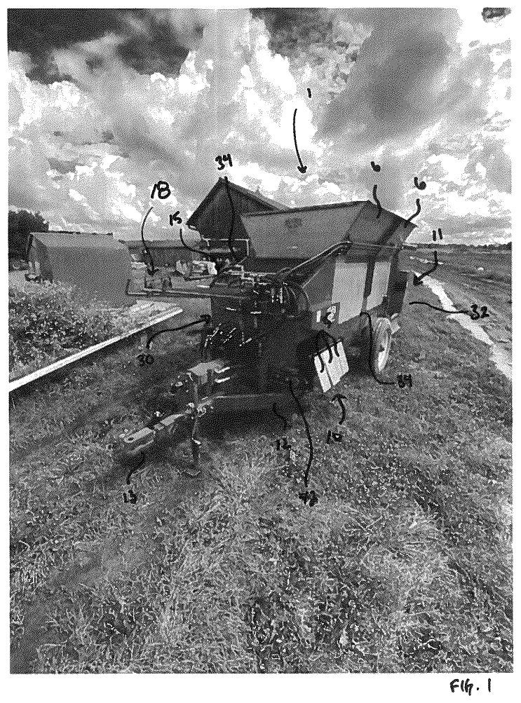

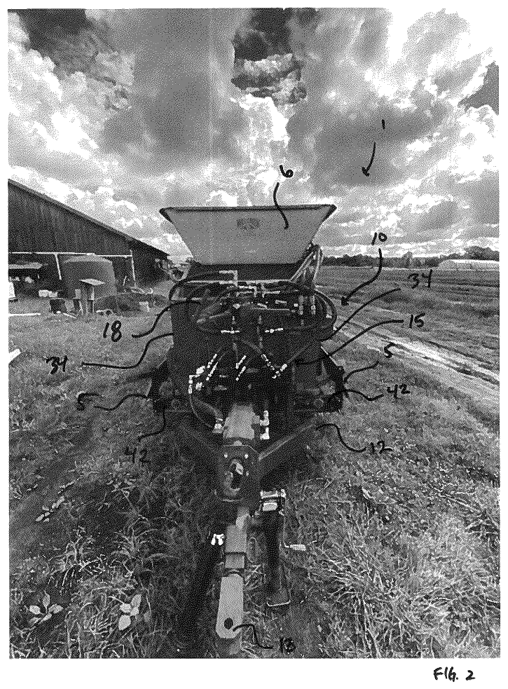

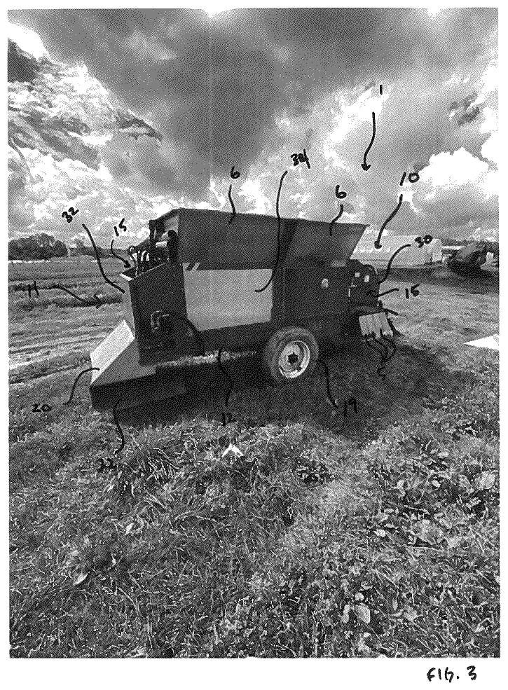

In describing the embodiment of the present invention, reference will be made herein to FIG. 1-14 f the drawings in which like numerals refer to like features of the invention.

FIGS. 1-3 depict perspective views of a first embodiment of an agricultural implement 1 according to the present invention. In this embodiment, the implement is constructed as a trailer for attachment to a tractor.

The agricultural implement 1 is structured having a forward end 30, rearward end 32, and sides 34. A leading sub-assembly 10 at the forward end 30 is followed by a trailing sub-assembly 11 at the rearward end 32. Both sub-assemblies 10 and 11 are carried on a common frame 12 attached to the rear end of a linkage assembly 13, which is adapted to be connected to a drawbar of a tractor or other transport vehicle. The frame 12 includes at least one axle including wheels 19. To ensure rigidity and carry load of the agricultural implement while maintaining the proper width of the agricultural bed during use, wheels 19 may comprise specialized tires, such as bias ply or radial ply aircraft tires. During testing, it was discovered that traditional agricultural implement rib tires, such as AG Rib Tires, prevented proper spreading of particulate material in the agricultural bed and bed wheeling, resulting in deficiencies in crop planting. Thus, the wheels 19 of the present invention are designed to maintain the agricultural implement above the agricultural bed, such that the wheels 19 can be properly maintained within the bed during use, ensuring effective planting operations.

Both sub-assemblies 10 and 11 are supported on common frame 12 that also supports a hopper 6 for containing particulate material. In one exemplary embodiment, agricultural implement 1 may include one or more hydraulic assemblies 15 in communication with a controller 18 for the selection of one or more application parameters during the application of particulate material. The application parameters of the particulate material generally comprise application depth, velocity, coverage degree, and the like.

In this tractor-pulled illustrative example, trailing sub-assembly 11 includes a rearward apron 20 for the discharge of particulate material from the hopper 6. A bib element 22 is secured on the side of apron 20 extending along the implement sides 34 of the leading subassembly 10, ensuring the discharge of particulate material from the trailing subassembly 11 onto the agricultural bed.

Leading subassembly 10 includes a plurality of discharge outlets 5 along the sides 34 for the discharge of particulate material therefrom. One or more conveyors 42 in the leading subassembly 10 may direct the discharge of particulate material from the hopper interior to the exterior of the agricultural implement 1 via one or more discharge outlets 5.

During operation of the agricultural implement 1, conveyor systems in the trailing subassembly will direct particulate material from at least one hopper 6 towards the rearward end 32 for the discharge via apron 20. The speed of the conveyor system may be controlled by the tractor operator via a controller 18, such that the rate of discharge may be adjusted during use of the agricultural implement 1.

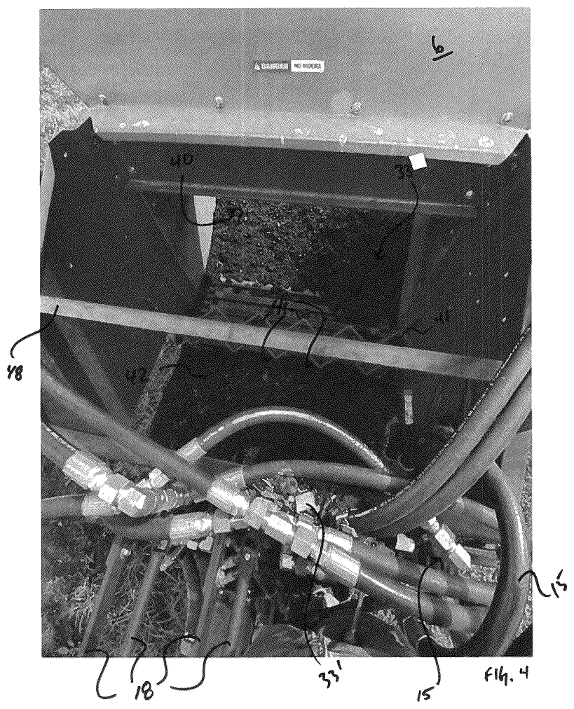

FIG. 4 depicts a perspective view of a portion of the agricultural implement, displaying leading subassembly 10. Hopper 6 can be loaded with particulate material 33 (and/or growth medium 33′) to an interior chamber 40. An hydraulic assembly 15 is in communication with a control rod 48 or conveyor(s) 42 to adjust the discharge of the particulate material from the agricultural implement 1. In this exemplary embodiment, control rod 48 includes mechanical structures, such as a plurality of paddle-like elements 41 or other mechanical extending-fin structure, which upon rotation prevents clumping of the particulate material during use as conveyor 42 moves particulate material to the agricultural implement sides 34.

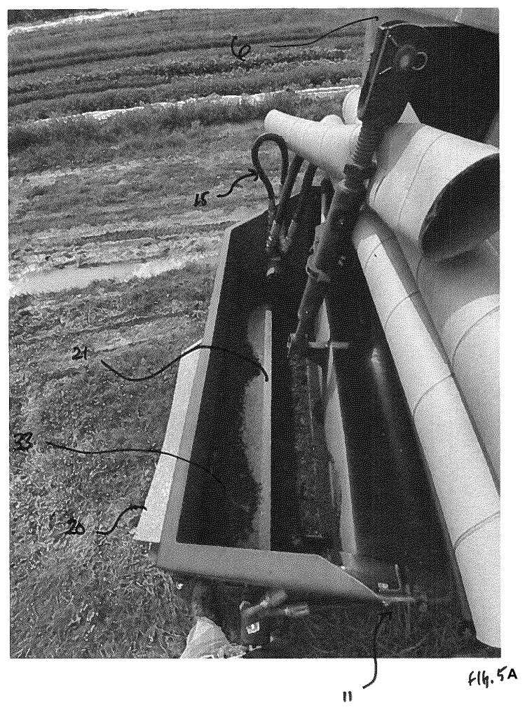

FIGS. 5A and 5B depict a perspective view of a portion of the exemplary embodiment of agricultural implement 1, displaying trailing subassembly 11. A trailing subassembly hopper 6′can be loaded in a manner similar to that of the leading subassembly 10, which is conveyed to the implement rearward end via conveyors (not shown) in an interior chamber. A de-clumping constituent, such as a brush element 21 consisting of a plurality of disc brushes, bristles, and the like, is introduced to prevent clumping of particulate material while ensuring an even distribution on the agricultural bed. A rotational paddle wheel may also provide sufficient de-clumping action. During operation of the agricultural implement, the plurality of disc brushes will rotate at an adjustable rate via the controller at the agricultural implement's forward end. Brush element 21 ensures uniformity of the particulate material discharged from the apron to ensure the proper layering for growth of a selected crop.

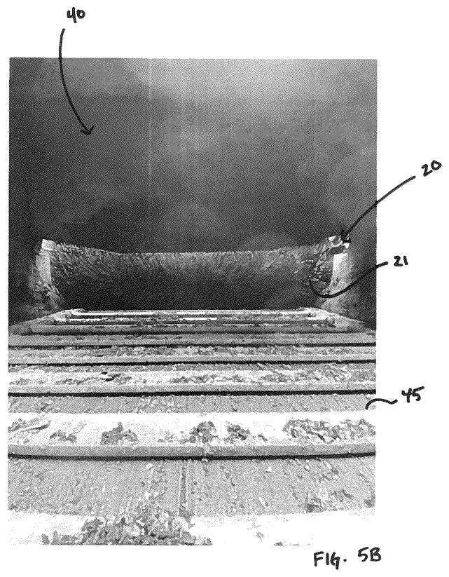

FIG. 6 depicts a perspective view of a portion of agricultural implement 1, displaying the interior mechanical assembly. The implement interior chamber 40 includes a conveyor 45 which may direct particulate material towards the agricultural implement forward end, which may discharge the material to the exterior sides of the implement using the leading subassembly 10, or towards the implement rearward end for discharge out the rearward apron 20. One or more drive chains 50 may be utilized to control the direction of the conveyor 45, which may be adjusted at any point during use of agricultural implement 1.

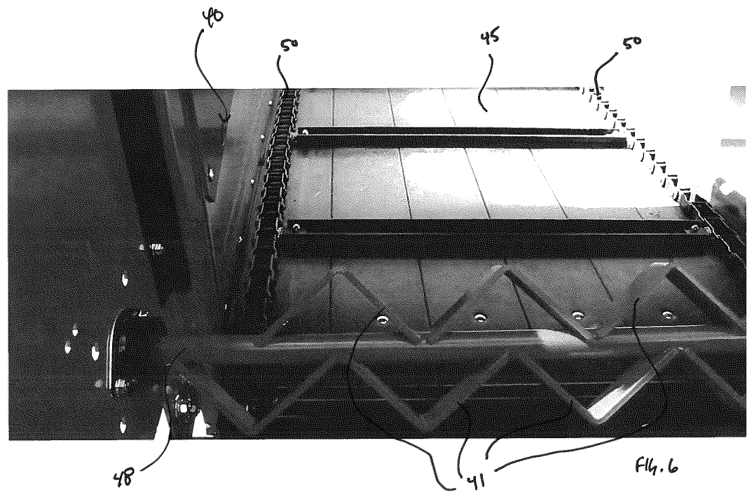

FIG. 7 depicts a perspective view of a portion of an exemplary embodiment of agricultural implement 1 according to the invention, displaying the trailing subassembly during use. The forward portion of the trailing subassembly 11 includes a roller element 30 secured to frame 12 at the implement sides 34 using a linkage arm 35. Roller element 30 incorporates a cellulose-based material 31 which is rotatable for placement over an agricultural bed 90 that has been seeded with a desired crop. As the cellulose-based material 31 is laid over the agricultural bed 90, particulate material is dropped from the hopper and evenly distributed over cellulose-based material 31 in a predetermined amount. As the tractor-pulled agricultural implement 1 moves along the agricultural bed, the cellulose-based material 31 will be placed on the top surface of the agricultural bed 90, which will subsequently be covered with particulate material. Bib element 22, ensures that the particulate material will remain on the cellulose-based material 31, and prevents particulate material 33 from entering the bed wheeling 92. Cellulose-based material 31 may comprise a paper or paperboard produced from chemical pulp pursuant to the kraft process (“kraft paper”), and may comprise a weight from 30 lb to 90 lb. (The kraft process is a process for conversion of wood into wood pulp, which consists of almost pure cellulose fibers.)

The selected kraft paper weight will vary depending on the crop grown. Crops whose density of planting and leaf formations are such that a leaf canopy quickly forms over the bed will need only a lighter weight of paper (30-40 lb) while a less dense planting of a slower growing plant will necessitate a heavier weight (60+ lb). Once the canopy is created, the quality of light hitting the bed top changes from red spectrum to more green spectrum causing the weed seeds to refrain from germinating.

The choice to use thicker or thinner paper will depend on how quickly the canopy created by the crop will form over the bed. A quicker forming canopy will allow for thinner, less costly paper to be used. Once the canopy is created, the quality of light hitting the bed top changes from a red spectrum to a more green spectrum causing the weed seeds to refrain from germinating.

Agricultural bed 90 utilizing the aforementioned method of applying cellulose-based material 31 and particulate material of the present invention has been found to promote microbial activity of the crops planted within agricultural bed 90, while preventing growth of weeds and other invasive species which would inhibit growth of a desired crop.

In alternate embodiments of the invention, moisture may be added to agricultural bed 90 prior to utilizing the agricultural implement of the invention to further accelerate growth of a desired crop, while ensuring decomposition of cellulose-based material 31. In one embodiment, the moisture may be applied just prior to the laying of the cellulose material by a liquid-delivering apparatus attached to the agricultural implement. To ensure effective growth of the desired crop, the depth at which particulate material is applied to the cellulose-based material 31 is predetermined and maintained at a constant rate and distribution depending on the desired crop. If particulate material 33 is applied to cellulose-based material 31 in an uneven or in an amount which is too deep or shallow, growth of the desired crop will be inhibited.

The one or more hydraulic assemblies may control a plurality of functions of the implement including speed of the brush element 21, speed of the conveyor(s) 45, 42, and may be power take-off (PTO) driven. (A power take-off is a mechanism that transfers mechanical power from an engine to operate external equipment, most commonly a rotating shaft that connects to implements like mowers or pumps. PTOs are prevalent in agricultural machinery for tasks like tilling and baling.) The rate at which particulate material and/or cellulose-based material 31 is discharged from the implement may be adjusted via the tractor speed, apron speed, brush element speed, or any combination thereof.

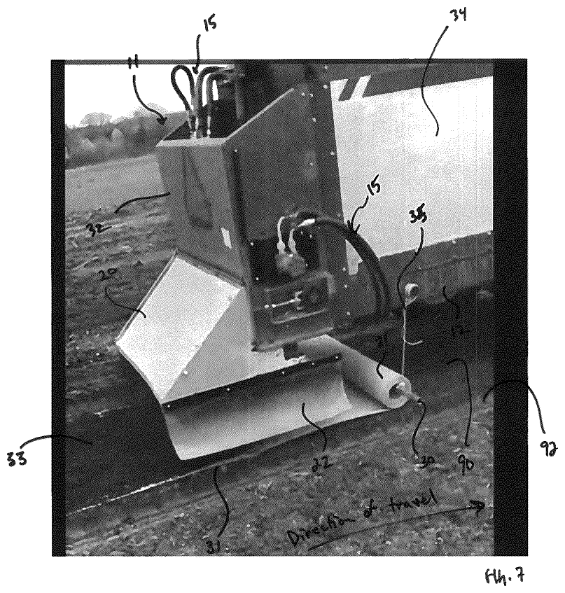

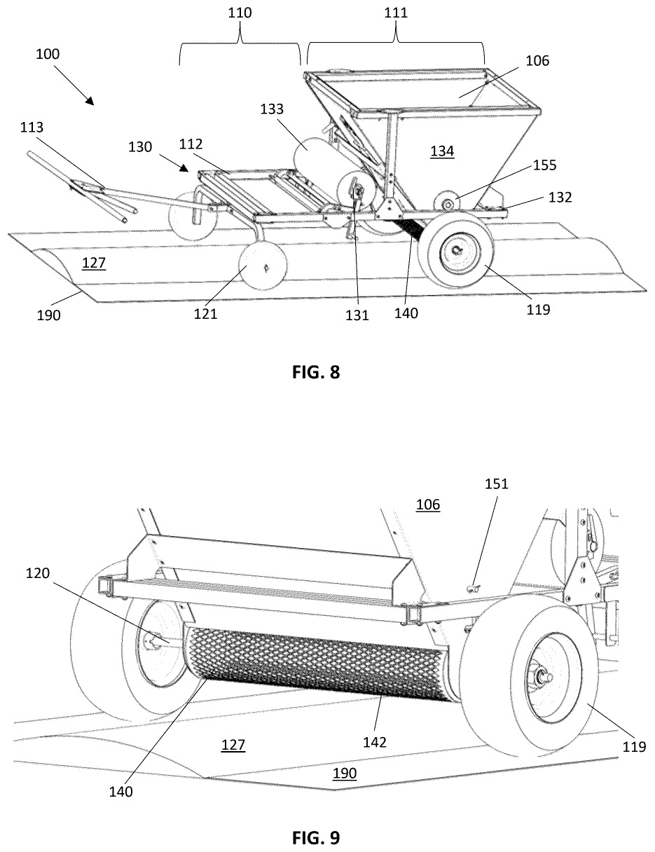

FIG. 8 depicts a second embodiment of the present invention, showing a perspective view of the agricultural implement 100, which may be a walk behind tractor or hand-pulled, on an agricultural bed 190, and is generally suitable for use on smaller acreage (typically less than 20 acres) of intensive growing operations—ideally, ones using a permanent bed system. Agricultural implement 100 identifies a form of a rotary drop instrument having a forward end 130, rearward end 132, and left and right sides 134. The rotary drop instrument is combined with a roller element 131 capable of delivering (rolling out) cellulose material 133 in a path underneath the rolling agricultural implement 100 along the agricultural bed. The rotary drop instrument works in tandem with a hopper 106 that holds the particulate material 127, a de-clumping mechanism, such as an agitator or paddle wheel, to ensure smooth flow of particulate material into a cylindrical spinner 140, a drive wheel 119 and axle 120 for operational mobility of cylindrical spinner 140, and optionally, a controller to operate an adjustment mechanism, allowing for the adjustment and moderation of particulate material flow into cylindrical spinner 140, which may include a flow control lever, automatic or hand operated, to adjust particulate material release, where the cylindrical spinner 140 is used to control the spread pattern and direction of the particulate material flow onto the cellulose layer atop the agricultural bed.

Referring to FIGS. 8 and 9, the leading sub-assembly 110 at the forward end 130 is followed by a trailing sub-assembly 111 at the rearward end 132. Both sub-assemblies 110 and 111 are carried by a common frame 112 attached to the rear end of a linkage assembly, handle, or hitch 113, which may be adapted to be connected to the drawbar of a tractor or other transport vehicle, or may be operational under manual operation. The common frame 112 secures at least one axle including rear wheels 119. To ensure rigidity and carry load of the implement while maintaining the proper width of the agricultural bed during use, rear wheels 119 may comprise specialized tires, such as bias ply or radial ply aircraft tires. Rear wheels 119 are designed to maintain the agricultural implement above an agricultural bed, such that the rear wheels 119 can be properly situated within the bed wheeling during use, ensuring effective planting operations. In one embodiment, front wheels 121 are applied, and may be smaller and of a different construct than rear wheels 119, insomuch as front wheels 121 need not be as weight-bearing as rear wheels 119, and need not include a shared axle, although a front shared axle is not prohibited.

Sub-assembly 111 includes a hopper 106 for containing particulate material 127. The agricultural implement 100 includes a sub-assembly to accommodate the rotary drop instrument, which preferably includes a cylindrical spinner 140 for dropping particulate material underneath the agricultural implement onto the distributed cellulose material, which lies over the agricultural bed 190.

The cylindrical spinner is depicted as a hollow, cylindrical drop or spinner spreader located about rear axle 120, where the cylindrical spinner 140 includes a grate-like outside surface having a plurality of apertures 142 for dropping particulate material therethrough during rotation or spinning.

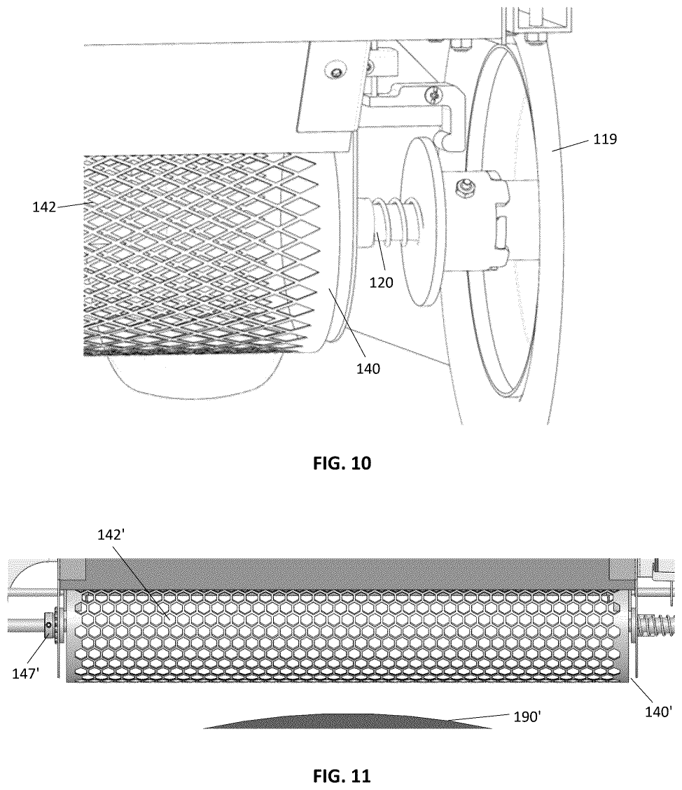

FIG. 9 depicts a partial view of the rear end of agricultural implement 100 showing the sub-assembly of the cylindrical spinner 140 for dropping particulate material from the hopper through the grate-like structure 142. FIG. 10 is a close-up view of the cylindrical spinner sub-assembly rotary drop instrument of FIG. 9. The rotary drop instrument may derive its rotation from the axle 120.

FIG. 11 depicts another embodiment of the rotary drop instrument, providing an isolated view of a cylindrical spinner 140′ having a different shaped grating 142′, shown over agricultural bed 190′. A rotational, mechanical subassembly 147′ is shown connecting the rotary drop instrument to axle 120′. In another embodiment, rotational, mechanical subassembly 147′ may be linked to axle 120′ or may be directed connected to axle 120′.

Agricultural implement 100 may include one or more hydraulic assemblies in communication with a controller for the selection of one or more application parameters during the application of particulate material, or preferably a manual, hand operated assembly in a similar fashion as a fertilizer spreader may be utilized. If automated, the application parameters of the particulate material may comprise application depth, velocity, coverage degree, and the like.

During operation of the agricultural implement 100, particulate material is directed from hopper 106 in the rearward end 132 downwards for discharge via an opening at the bottom of hopper 106. The speed of the discharge is controlled by the tractor operator via a controller or manual control, such that the rate of discharge may be adjusted in-situ during use.

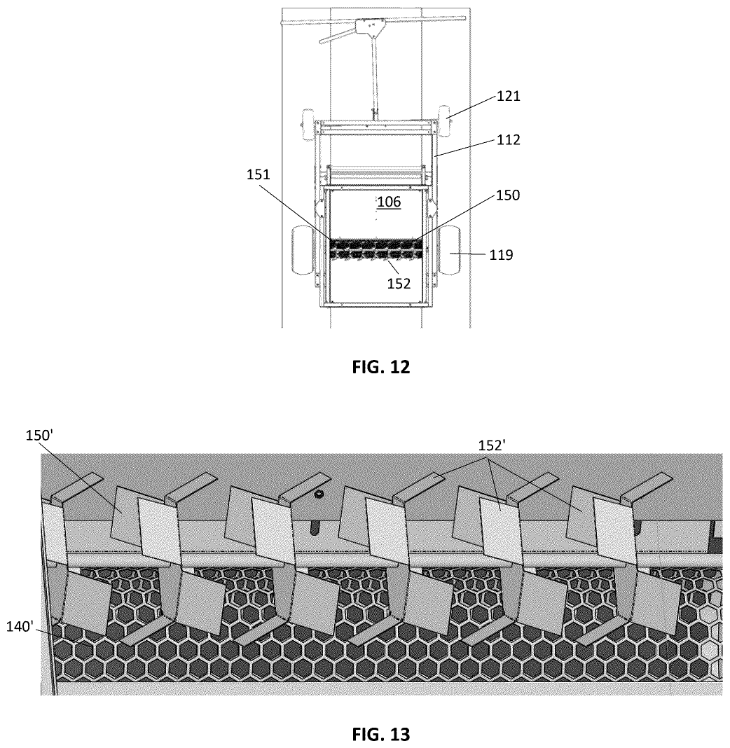

FIG. 12 is a top view of the agricultural implement 100 of FIG. 8. Located within hopper 106 proximate an opening for particulate material to drop into cylindrical spinner spreader 140, is an agitator or paddle wheel 150 to ensure smooth flow of particulate to cylindrical spinner 140. Paddle wheel 150 is situated across the width of hopper 106 on a rotating axle 151, and rotates under a linkage assembly 155 with rear axle 120. While rotating, paddle wheel 150 presents paddle fins 152 extending radially outwards from rotating axle 151.

Linkage assembly 155 may be a simple rotating gear assembly, such as a circular mechanical component with interlocking teeth designed to transmit torque and modify speed between one shaft or axle and another.

FIG. 13 depicts a magnified view of an embodiment of paddle wheel 150′, having paddle fins 152′ shaped to de-clump particulate material upon rotation within the lower portion of the hopper, sending the particulate material to the cylindrical spinner 140′.

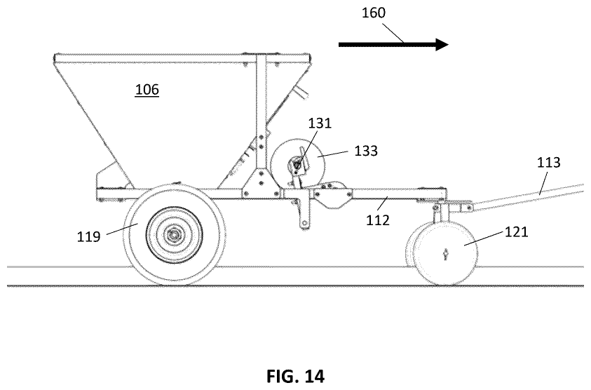

FIG. 14 is a side view of agricultural implement 100 depicting the spatial relationship among the roller element 131 that delivers cellulose material 133 to the agricultural bed, which is then exposed to falling particulate material and growth medium delivered from the hopper 106, de-clumped internally by a rotating paddle wheel.

Operationally, as the agricultural element is moved along the agricultural path in the direction of arrow 160, roller element 131 rotates and drops the paper-like cellulose material onto the agricultural bed. As the agricultural element traverses the path over the dropped cellulose material, the paddle wheel rotates and causes particulate material to fall out of the bottom end of the hopper onto the cellulose material. This process continues as long as the operator elects to roll the agricultural element along the path, and allow particulate to drop down from the hopper.

Thus, having described the invention, what is claimed is:

1. An agricultural implement for spreading particulate material on an agricultural bed, and placing cellulose-based material on said agricultural bed for reducing the growth of invasive weeds while providing sufficient nutrients to the selected particulate material ensuring successful crop growth, said agricultural implement comprising:
a forward end, a rearward end, a leading sub-assembly at said forward end followed by a trailing sub-assembly at said rearward end;
a hopper for containing said particulate material;
said cellulose-based material supported on a delivery apparatus including a roller element secured to a common frame for securing a rotatable roll of said a cellulose-based material for placement over said agricultural bed, which has been seeded with a desired crop;
an agitator or paddle wheel including a plurality of paddles or fins situated across a width of said hopper on a rotating axle located within said hopper, said paddles or fins extending radially outwards and rotating under a linkage assembly in mechanical communication with a rear axle;
a cylindrical drop or spinner spreader located about a rear axle of said agricultural implement, where said spinner spreader includes a grate-like outside surface having a plurality of apertures for dropping said particulate material therethrough during rotation or spinning; and
a controller to control the flow of said particulate material to said spinner spreader, allowing for the adjustment and moderation of particulate flow.

2. The agricultural implement of claim 1 wherein said controller is configured to control application parameters of the particulate material including depth, velocity, and/or coverage degree.

3. The agricultural implement of claim 2 wherein said controller comprises a manual, hand operated assembly to limit or control the delivery of particulate material to said spinner spreader.

4. The agricultural implement of claim 3 including a flow control lever to adjust release of said particulate material.

5. The agricultural implement of claim 1 wherein said agitator or paddle wheel rotates to ensure de-clumping and smooth flow of said particulate material falling into said spinner spreader.

6. The agricultural implement of claim 5 wherein said paddle wheel is situated across a width of said hopper on a rotating axle, and rotates via said linkage assembly with a rear axle.

7. The agricultural implement of clam 1 including a rearward apron for the discharge of said particulate material from said hopper.

8. The agricultural implement of claim 7 including a bib element secured on a side of said apron extending along sides of said agricultural implement, ensuring the discharge of particulate material onto said agricultural bed.

9. The agricultural implement of claim 1 including one or more hydraulic assemblies in communication with said controller for the selection of one or more application parameters during the delivery of said particulate material.

10. The agricultural implement of claim 1 wherein said cellulose-based material comprises a paper or paperboard product produced from chemical pulp pursuant to a kraft process, forming kraft paper, and comprises a weight from 30 lb to 90 lb.

11. The agricultural implement of claim 1 including a plurality of discharge outlets along sides of said agricultural implement for the discharge of particulate material therefrom.

12. The agricultural implement of claim 1 wherein one or more conveyors in said leading sub-assembly direct discharge of said particulate material from the hopper interior to an exterior of the agricultural implement 1 via one or more discharge outlets.

13. A method of treating an agricultural bed utilizing an agricultural implement, said method comprising:
traversing said agricultural implement along said agricultural bed;
placing cellulose-based material on said agricultural bed for reducing growth of invasive weeds while providing sufficient nutrients to selected particulate material, ensuring successful crop growth, wherein said agricultural implement comprises:
a forward end, a rearward end, a leading sub-assembly at said forward end followed by a trailing sub-assembly at said rearward end;
a hopper for containing said particulate material;
said cellulose-based material supported on a delivery apparatus including a roller element secured to a common frame for securing a rotatable roll of said a cellulose-based material for placement over said agricultural bed;
an agitator or paddle wheel including a plurality of paddles or fins situated across a width of said hopper on a rotating axle located within said hopper, said paddles or fins extending radially outwards;
a cylindrical drop or spinner spreader located about a rear axle of said agricultural implement, where said spinner spreader includes a grate-like outside surface having a plurality of apertures for dropping said particulate material therethrough during rotation or spinning; and
a controller to control the flow of said particulate material to said spinner spreader, allowing for the adjustment and moderation of particulate flow; and
spreading said particulate material on said cellulose-based material on said agricultural bed utilizing said agricultural implement.

14. The method of claim 13 including controlling application parameters of said particulate material including depth, velocity, and/or coverage degree.

15. The method of claim 13 including rotating said a cylindrical drop or spinner spreader in mechanical communication with said rear axle.

16. The method of claim 13 including rotating said agitator or paddle wheel under a linkage assembly in mechanical communication with said rear axle.

17. The method of claim 13 wherein said cellulose-based material comprises a paper or paperboard product produced from chemical pulp pursuant to a kraft process, forming kraft paper, and comprises a weight from 30 lb to 90 lb.

18. The method of claim 13 including moving said agricultural implement along the agricultural path such that said roller element rotates and drops said cellulose-based material onto said agricultural bed, and as said agricultural implement traverses said agricultural path over dropped cellulose-based material, said paddle wheel rotates and causes particulate material to fall out of a bottom end of said hopper onto said cellulose-based material.
